(19) United States
(12) Patent Application Publication
(10) Pub. No.: US 2025/0206417 A1
(43) Pub. Date: Jun. 26, 2025

(54) CRANE HAVING ACTIVE FALLBACK PROTECTION

(71) Applicant: Liebherr-MCCtec Rostock GmbH, Rostock (DE)

(72) Inventors: Stephan KOERTGE, Bludenz (AT); Christian MATT, Feldkirch (AT); Martin DONA, Schruns (AT); Matthias SCHOLZ, Frastanz (AT)

(21) Appl. No.: 18/986,616

(22) Filed: Dec. 18, 2024

(30) Foreign Application Priority Data
Dec. 22, 2023 (DE) 10 2023 136 579.7

(51) Int. Cl. B63B 27/10

(52) U.S. Cl. CPC B63B 27/10

(57) ABSTRACT

The disclosure relates to a crane comprising a carrier structure, a boom, which is connected to the carrier structure so as to be pivotable about a horizontal tilt axis, a guy frame, which is connected to the carrier structure and via which the boom is guyed by means of length-variable guy cables, and a fallback protection device, which is arranged on the guy frame and is configured to block or brake tipping of the boom towards the guy frame in a critical state of the crane, in particular in the event of a load shift, wherein the fallback protection device comprises at least one stabilising strut, with which the boom comes into contact when it tilts back by a defined boom angle. According to the disclosure, the stabilising strut is configured as a rigid element, which follows the boom above the defined boom angle.

### CROSS REFERENCE TO RELATED APPLICATION

The present application claims priority to German Patent Application No. 10 2023 136 579.7 filed on Dec. 22, 2023. The entire contents of the above-listed application are hereby incorporated by reference for all purposes.

### TECHNICAL FIELD

The present disclosure relates to a crane and to a fallback protection device for such a crane.

### BACKGROUND

Cranes of this kind are often configured as heavy-duty deck cranes or heavy-duty offshore cranes and have a boom that can tilt about a horizontal axis and is guyed via a guy frame by means of length-variable guy cables. The boom is tilted back and forward by actuating the guy cables via a boom hoist.

### SUMMARY

In cranes of this kind, owing to the rolling behaviour of the ship, which can for example occur in the event of a load shift, but also the loss of a load or movements on deck, the boom can swing back towards the guy frame, which can cause damage to the boom and the guy frame. For this reason, it is known from the prior art to equip such cranes with hydraulic fallback protection cylinders, which contact the boom at a specified maximum boom angle and block or brake said boom from swinging back in the event of a load shift.

A drawback of these systems is the fact that the hydraulic cylinders used have a large differential volume and therefore require a large oil volume, which has to be conveyed in a short time. In this case, the cylinders need to be coordinated with the entire system in terms of the maximum length and the holding force.

Furthermore, hydraulic cylinders are susceptible to buckling owing to their design, which is why comparatively large and heavy components need to be installed. The maximum length of the cylinders is usually limited for this reason, meaning that the entire hazardous range often cannot be covered (i.e., the fallback protection only intervenes at comparatively large boom angles).

Furthermore, when supporting the boom, the oil is compressed and therefore the distance between the boom and the guy frame is reduced, since the cylinders are supported on a compressible oil column. This inevitably results in slackening of cables in the guy cables or in the boom hoist. Depending on the rolling movement of the ship, the boom can enter a freefall phase, which can result in the boom structure, the boom hoist and/or other components in the load path becoming overloaded or failing.

The problem addressed by the present disclosure is therefore to provide a generic crane comprising a fallback protection device in which the above-mentioned drawbacks do not occur and which reduces the extent of damage to a minimum in the event of a load shift.

According to the disclosure, this problem is solved by a crane and by a fallback protection device as described herein.

Accordingly, a crane is proposed which comprises a carrier structure, a boom, which is connected to the carrier structure so as to be pivotable about a horizontal tilt axis, a guy frame, which is connected to the carrier structure, and a fallback protection device arranged on the guy frame. The boom is guyed via a guy frame (also called an A-frame) by means of a length-variable guy system, in particular guy cables. As described at the outset, the boom can in particular tilt back and forward by the length of the guy system being varied by means of a boom hoist. The boom can be a lattice boom. Alternatively, a box-type boom is also conceivable.

The fallback protection device is configured to block or brake tipping of the boom towards the guy frame in a critical state of the crane, in particular in the event of a load shift. This prevents damage to the guy frame and the boom, since the latter is blocked or braked by the fallback protection device before it reaches the guy frame. For this purpose, the fallback protection device comprises at least one stabilising strut, with which the boom comes into contact when it tilts back when it reaches the defined boom angle. Below the defined boom angle, the boom is not in contact with the stabilising strut (in the following, for the sake of simplicity, reference is only made to “the stabilising strut”, but this should always mean at least one stabilising strut).

According to the disclosure, the stabilising strut is not configured as a piston-cylinder unit, for example, but as a rigid element, for example as a steel beam. The stabilising strut is also not immovably fastened to the guy frame, but instead actively or passively follows the boom above the defined boom angle. To do this, above the defined boom angle, the stabilising strut is inserted when the boom tilts back such that it is always in contact with the boom. Conversely, above the defined boom angle, the stabilising strut withdraws when the boom tilts forward in order to remain in contact with the boom. For this purpose, the fallback protection device comprises a cable winch system, by means of which the stabilising strut can be actively inserted and/or actively withdrawn relative to the guy frame.

The stabilising strut following the boom ensures that, above the defined boom angle, the stabilising strut and thus the boom can be directly blocked or braked if a critical state occurs, such as a load shift. The hazardous range covered by the fallback protection device is thus specified by the defined boom angle, which should therefore be as small as possible (in order to protect the greatest possible angular range). This can be achieved according to the disclosure in that the configuration of the stabilising strut as a rigid element allows for a greater length and thus a greater hazardous range being covered. As a result, defined boom angles of 60°, but also smaller angles of, for example, 50° or less can be reached (i.e., in the latter case, the fallback protection device according to the disclosure would be active even from a boom angle to the horizontal of 50° or less).

In normal operation, the stabilising strut in particular follows the boom freely, i.e. without significant force being exerted on the boom. In normal operation, it can therefore also be freely tilted back and forward in particular in the hazardous range, i.e. above the defined boom angle. Only in the critical state is insertion of the stabilising strut and thus any further tilting back of the boom above the defined boom angle blocked or braked.

Compared with the solution based on hydraulic cylinders, the solution according to the disclosure, in which the stabilising strut is inserted and/or withdrawn by a cable winch, has several advantages. For instance, the at least one cable winch of the cable winch system requires considerably less oil than the known hydraulic cylinders (in a hydraulically actuated winch) or no oil at all (in an electrically actuated winch).

Furthermore, a rigid securing structure allows greater lengths of the stabilising strut to be implemented, such that the boom and the stabilising strut can be in contact even at a lower defined boom angle. As a result, the boom can be blocked or braked earlier and thus a greater hazardous range can be covered.

In a winch-based system, the same basic system of the fallback protection device can also be used with different reeving setups for different cases or different cranes. The change in reeving is a comparatively small intervention in the system. The braking force could, for example, be varied by adding or removing braking units (modular system).

Furthermore, a rigid stabilising strut holds the boom relative to the guy frame in a fixed position, such that cables are prevented from slackening in the guying system.

Lastly, winches are considerably less susceptible to corrosion than a cylinder, especially the piston rod. After relatively long periods of downtime, corrosion of the piston rod can occur in hydraulic cylinders, which makes it more likely that the seals will start to leak and become damaged.

In the present case, the indications of the boom angle (e.g. larger/smaller boom angle) relate in particular to the angle between the longitudinal boom axis and the horizontal.

The defined boom angle can be in the range of 50-70°, optionally in the range of 50-60°, although defined boom angles of less than 50° or, depending on the construction of the crane, of greater than 70° are also possible.

Theoretically, a defined boom angle of less than 40°, less than 30°, less than 20°, less than 10° or even up to 0° in extreme cases could be achieved by the fallback protection device according to the disclosure, although such a large hazardous range being protected would come at the price of increased weight of the fallback protection device. For this purpose, the stabilising strut can for example be pivotally fastened to the guy frame and/or can have a shape that is curved downwards or towards the boom.

The fallback protection device according to the disclosure is optionally configured such that the boom can be tilted back up to an angle of 90° (i.e., the protected hazardous range reaches to) 90°.

In a possible embodiment, it is provided that the stabilising strut can both be actively inserted and actively withdrawn by means of the cable winch system. When the boom tilts forward, the stabilising strut actively withdraws with it and synchronously follows the boom until the boom falls below the defined boom angle. Conversely, the stabilising strut is synchronously actively inserted towards the boom that is tilting back by the cable winch system above the defined boom angle.

For this purpose, the cable winch system optionally comprises a cable winch configured as a traversing winch, which can be actuated in both directions. A cable which is not fastened to the cable winch by one end, but is fastened to the stabilising strut by both ends, is mounted on the cable winch. By rotating the cable winch in one or the other direction, the stabilising strut can be inserted or withdrawn. By using a single winch for inserting and withdrawing the stabilising strut, fewer components need to be installed. The cable is optionally guided to different ends of the stabilising strut over a plurality of deflection rollers and is fastened there. The cable winch system can further comprise cable winders, in order to avoid cables slackening. They can each comprise one or more further deflection rollers.

Alternatively, the stabilising strut can be inserted and withdrawn via two separate “normal” cable winches, wherein one of the cable winches pulls the stabilising strut in the desired direction, while the other cable winch unwinds the other cable, so that it follows the movement of the stabilising strut.

In another possible embodiment, it is provided that the stabilising strut can be actively withdrawn and only passively inserted via the cable winch system. The withdrawal can take place via a normal cable winch. The passive insertion in particular takes place by the boom tilting back by means of the guy system or the boom hoist, which boom exerts a corresponding force on the stabilising strut. To do this, the cable winch can be disengaged for the insertion, such that it can rotate freely, brought about by the boom tilting back. The cable winch could alternatively also be operated by a defined counter-pressure, which does not damage the boom, prevents cables from slackening, and ensures permanent contact with the boom.

In another possible embodiment, it is provided that a receiving apparatus is arranged on the boom, with which apparatus the stabilising strut comes into contact when the defined boom angle is reached. This produces a defined contact surface between the stabilising strut and the boom. The receiving apparatus optionally has a funnel-shaped opening region, into which an end of the stabilising strut facing away from the guy frame is inserted when contacting the receiving apparatus. This ensures that the stabilising strut is always correctly inserted into the receiving apparatus. The receiving apparatus can be arranged on the side of the boom facing the guy frame.

The receiving apparatus can be fastened to the boom in an articulated manner, for example in order to allow the stabilising strut to follow said boom in the vertical direction or to compensate for a vertical relative movement. Alternatively, the receiving apparatus can be securely fastened to the boom, e.g. when using a curved stabilising strut.

In another possible embodiment, it is provided that the stabilising strut is pivotally mounted on the guy frame, in order to compensate for a vertical movement of a contact region of the boom, which is contacted by the stabilising strut (this can be the above-mentioned receiving apparatus), when following a pivoting movement of the boom above the defined boom angle. When the boom pivots, the contact region not only moves horizontally relative to the fastening point of the stabilising strut, but also in the vertical direction. This has to be compensated for when the stabilising strut follows the boom. The stabilising strut can in particular have a straight or linear shape.

In order to compensate for the vertical movement of the contact region while following, the stabilising strut can be actively pivotable about its mounting on the guy frame by means of an actuator, for example by means of a hydraulic cylinder, which is inserted or withdrawn in a controlled manner.

Alternatively, according to another possible embodiment, it is provided that the stabilising strut has a curved shape and is configured such that, when following a pivoting movement of the boom above the defined boom angle, a vertical movement of a contact region of the boom, which is contacted by the stabilising strut (this can be the above-mentioned receiving apparatus), corresponds to the vertical movement of an end portion of the stabilising strut contacting the contact region. In other words, the stabilising strut can be bent or curved such that, when inserting and withdrawing the stabilising strut, its end region precisely describes such a curve that it follows the contact region of the boom when it tilts back or forward. As a result, the stabilising strut does not need to also be followed in the vertical direction, but instead can be non-pivotally mounted on the guy frame, for example. Here, the stabilising strut is in particular curved downwards.

In another possible embodiment, it is provided that the fallback protection device comprises a pressure accumulator, which is “charged” when the stabilising strut is inserted and, when the stabilising strut is withdrawn, is discharged again and thus assists the cable winch system, which withdraws the stabilising strut. The pressure accumulator can be a hydraulic accumulator or a gas accumulator.

In another possible embodiment, it is provided that the fallback protection device comprises a brake device, which, when activated, actively or passively brakes insertion of the stabilising strut. The stabilising strut is optionally braked to a stop in this case. The brake device is optionally automatically activated by a control apparatus (e.g. the crane controller) when a critical state is identified (e.g. a load shift), but can also be activated as standard whenever the boom is not being moved (i.e. activating the brake device when the boom comes to a stop).

The brake device can comprise an active frictional brake system, which is hydraulically, electrically or pneumatically actuated. Alternatively or additionally, the brake device can comprise an active positive-engagement brake system, which is hydraulically, electrically or pneumatically actuated. It is also conceivable for the brake device to comprise a passive brake system, which brakes after activation without any further force effect and for example varies the brake force depending on the loading (e.g. by means of a self-locking wedge).

In another possible embodiment, it is provided that the crane comprises a detection apparatus comprising a sensor system for detecting a critical state of the crane, in particular a load shift. The sensor system can comprise at least one acceleration sensor, which can for example be arranged on the boom, the guy frame, a hoist cable or load-receiving means, or at any other point on the carrier structure. It is also conceivable for the acceleration sensor to be part of the fallback protection device. Alternatively or additionally to said acceleration sensor, other sensors can be provided, for example at least one inertial measurement unit (IMU), at least one proximity sensor, at least one mechanical limit switch and/or at least one pressure sensor. These sensors can be arranged at different points in order to monitor the crane and identify critical states.

The crane optionally further comprises a control unit, which receives data from the detection apparatus or sensor system and is configured to identify a critical state on the basis of the received data and, as a response thereto, to actuate a locking device or a brake device of the fallback protection device such that the boom is braked or blocked above the defined boom angle. The control unit can be the crane controller or a separate control unit.

As an alternative to a selectively braked solution, which requires a critical state to be identified, the brake can be activated whenever the boom is not tilted. In this case, a sensor system for identifying a critical state can be omitted.

In another possible embodiment, it is provided that the fallback protection device comprises at least one actuation unit comprising a mount which is fastened to the guy frame and in which the stabilising strut is movably mounted, wherein said cable winch system is part of the actuation unit. The actuation unit mounts the stabilising strut in particular on the guy frame. In the case of a linear or straight stabilising strut which has to be vertically followed when the boom pivots, the actuation unit can comprise an actuator, which actively pivots the stabilising strut or the mount when the boom tilts.

In another possible embodiment, it is provided that the actuation unit comprises said brake device. In this case, the brake device can be integrated in the mount or can be part of the mount. The brake device can for example comprise one or more brake elements, which brake the stabilising strut in a frictional or positively engaged manner, or passively, as described above. Alternatively, the brake device can be integrated in the cable winch system. For example, the stabilising strut can be braked by braking the corresponding cable winch. The brake device can be an active brake system comprising a single-reeved or multiple-reeved cable winch.

In another possible embodiment, it is provided that the stabilising strut has a curved shape, as described above, wherein the mount has a curved shape in order to movably receive the curved stabilising strut. In this case, the mount can be immovably fastened to the guy frame.

In another possible embodiment, it is provided that the fallback protection device comprises at least two stabilising struts, which can optionally be inserted and/or withdrawn via separate cable winch systems. Exactly two stabilising struts can be provided, which can optionally be mounted laterally or in the lateral regions of the guy frame. Alternatively, more than two stabilising struts can be provided, in particular a multiple of two stabilising struts. They can for example be arranged one above the other on the guy frame and ensure yet more effective braking of the boom, in particular in cranes having a very large and heavy boom.

In another possible embodiment, it is provided that the carrier structure comprises a slewing platform which is mounted on a substructure so as to be rotatable about a vertical axis of rotation and on which the boom, the guy frame and the fallback protection device are arranged. The crane according to the disclosure is optionally a deck crane, in particular a heavy-duty offshore crane or a heavy-duty deck crane, wherein the substructure is connected to a ship's hull.

The present disclosure further relates to a fallback protection device for a crane according to the disclosure. This clearly results in the same properties and advantages as for the crane according to the disclosure. All the embodiments and configuration options for the fallback protection device that are described in relation to the crane are therefore also applicable to the fallback protection device according to the disclosure, in any combination.

Further features, details and advantages of the disclosure are found in the following exemplary embodiments, which are explained with reference to the drawings, in which:

### DETAILED DESCRIPTION

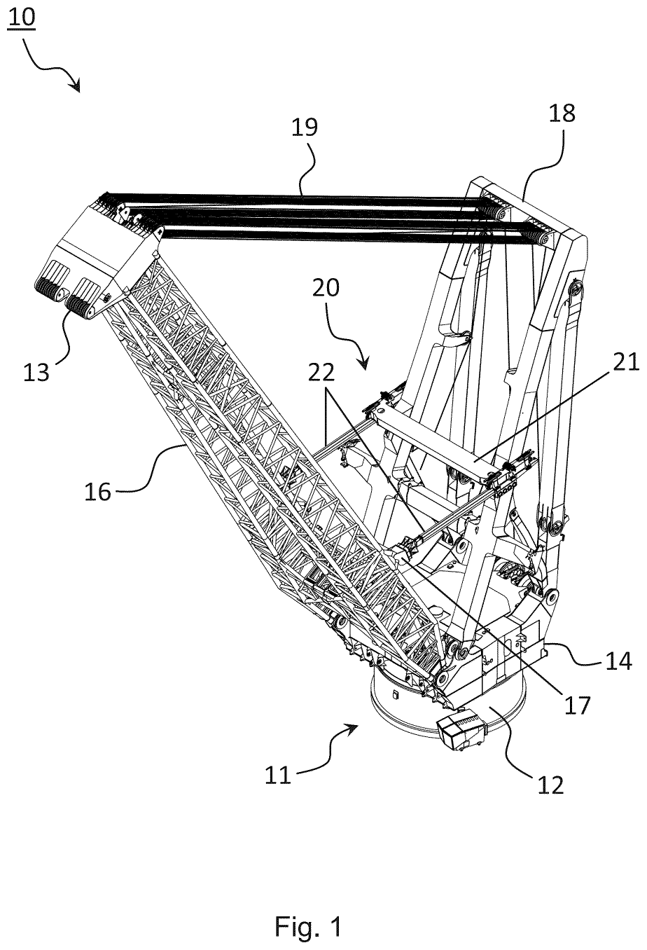

FIG. 1 is a perspective view of a first exemplary embodiment of the crane according to the disclosure, wherein only the carrier construction comprising the boom is shown;

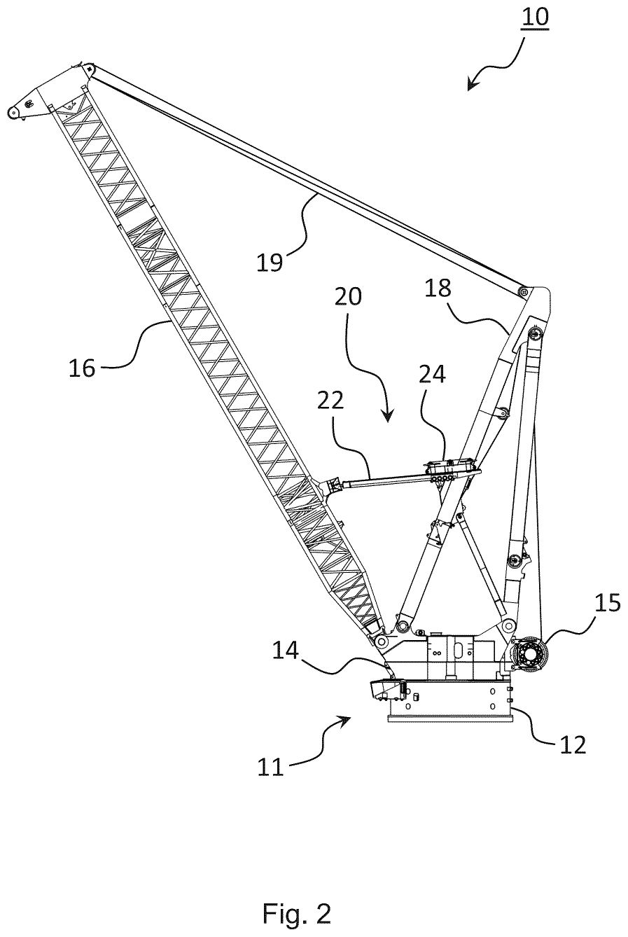

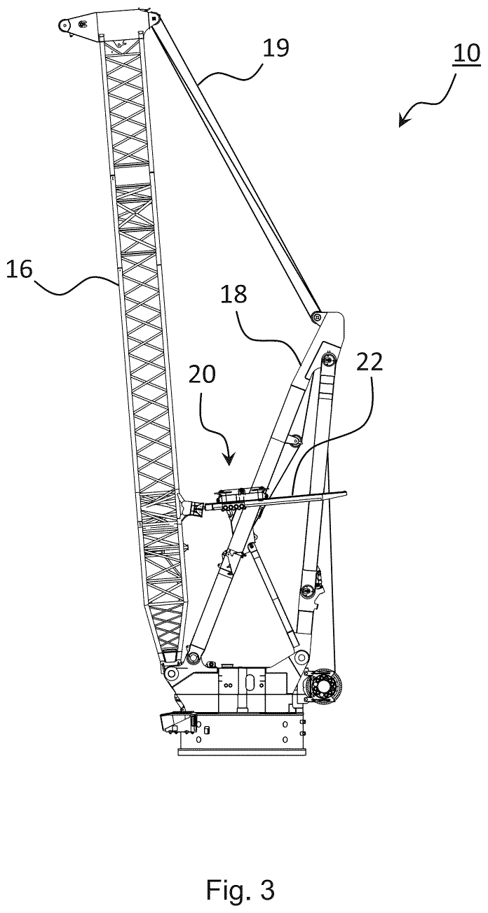

FIGS. 2-3 are side views of the crane according to the exemplary embodiment from FIG. 1 with the boom in different positions;

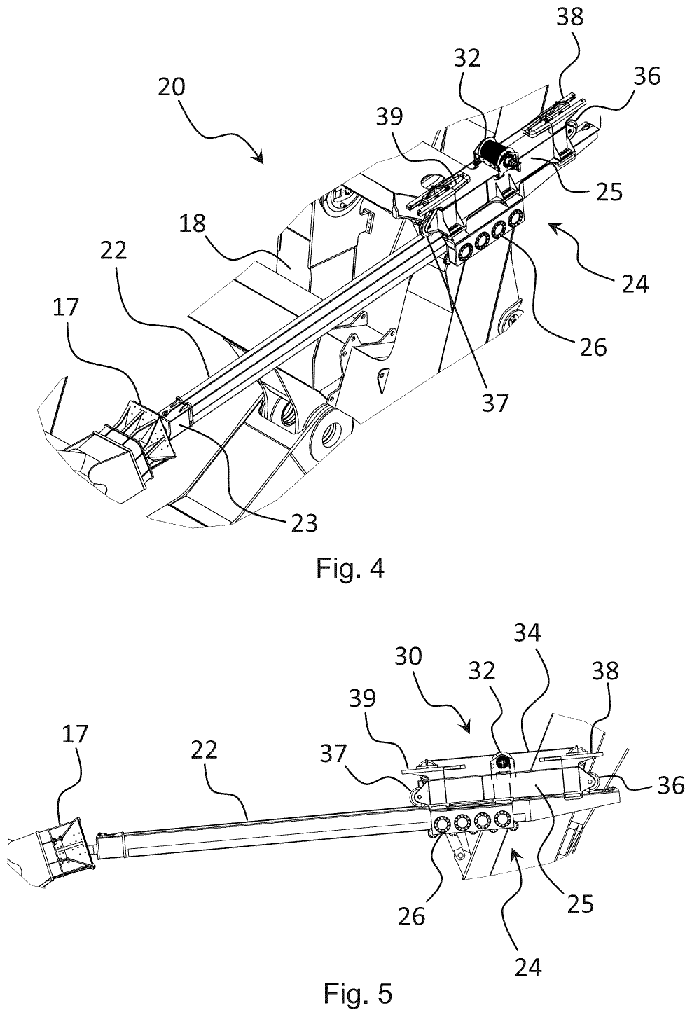

FIGS. 4-5 are a perspective view and a side view, respectively, of a stabilising strut according to an exemplary embodiment; and

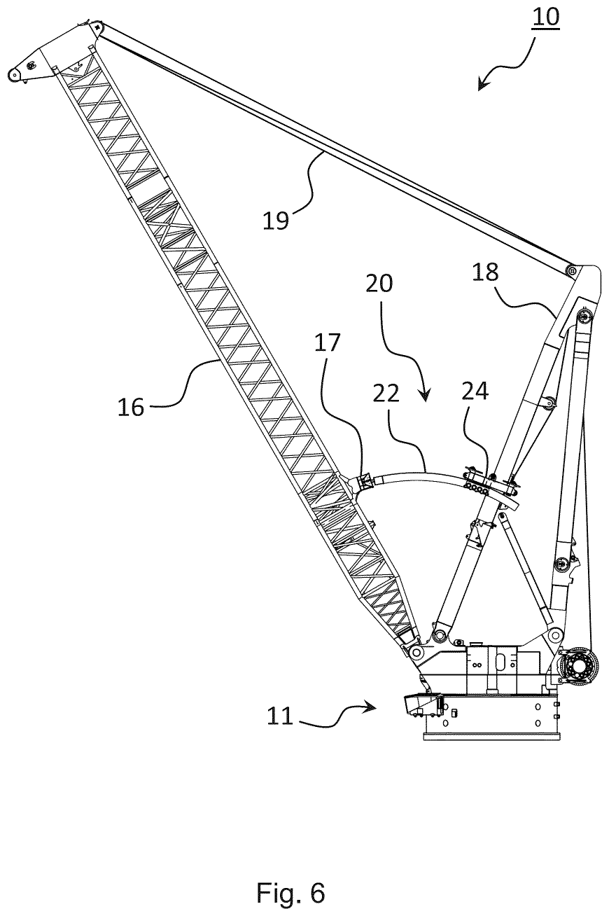

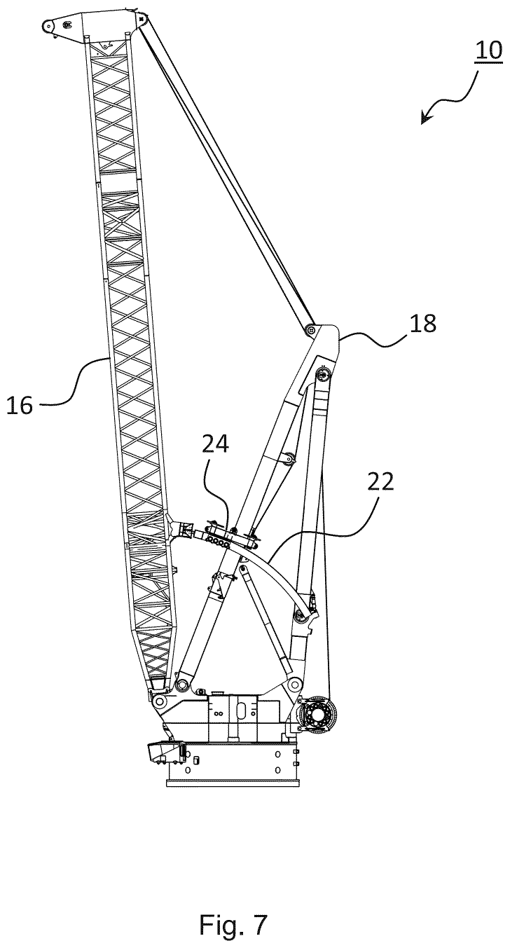

FIG. 6-7 are side views of the crane according to the second exemplary embodiment with the boom in different positions.

### DETAILED DESCRIPTION

FIG. 1 is a perspective view of an exemplary embodiment of the crane 10 according to the disclosure in the form of a heavy-duty offshore crane, wherein the ship's hull is not shown. The crane 10 comprises a carrier structure 11 having a substructure 12 (in this exemplary embodiment, connected to the ship's hull (not shown)) and a slewing platform 14 which is mounted on the substructure 12 so as to be rotatable about a vertical axis of rotation.

The crane 10 comprises a boom 16, which is articulated to the slewing platform 14 so as to be pivotable about a horizontal tilt axis. In the exemplary embodiment shown, the boom 16 is configured as a lattice boom comprising two boom beams which taper to a boom head 13, in order to give the boom 16 the required stability for the considerable loads to be lifted. The boom head 13 has a plurality of deflection rollers, over which a multiple-reeved hoist cable (not shown) is guided and is connected to a hoist block (also not shown).

A guy frame 18 is fastened to the slewing platform 14, on the end of which guy frame a plurality of deflection rollers are located, over which guy cables 19 (=guy system) are guided to the boom head 13. The boom 16 can be tilt back and forward by means of a boom hoist, which can comprise one or more guy cable winches 15 (cf. FIG. 3) arranged on the rear of the slewing platform 14.

Owing to the rolling behaviour of the ship, the boom 16 can swing back towards the guy frame 18 in critical situations, in particular in the event of a load shift, which can cause significant damage. To prevent this, the crane 10 comprises a fallback protection device 20, which is arranged on the guy frame 18 and is configured to catch and brake or stop the boom 16 from swinging back.

In the exemplary embodiment in FIG. 1, the fallback protection device 20 comprises two stabilising struts 22, which are configured as linear, rigid beams extending in parallel with one another. FIGS. 4-5 are a perspective view and a side view, respectively, of one of the stabilising struts 22.

The rigid stabilising struts 22 are each mounted on the guy frame 18 via an actuation unit 24 and have an end 23 pointing towards the boom 16, which is in contact with the side of the boom 16 pointing towards the guy frame 18 above the defined boom angle. The length of the stabilising struts 22 therefore determines the defined boom angle. The receiving apparatuses 17, which form the contact regions for the ends 23 of the stabilising struts 22 and, in the exemplary embodiment shown, have a funnel-shaped receptacle that is open towards the guy frame 18 and ensures that the stabilising struts 22 are properly inserted into the receiving apparatuses 17, are located on the side of the boom 16 pointing towards the guy frame 18. In the exemplary embodiment shown, the defined boom angle is approx. 60° relative to the horizontal, but can also be larger or smaller depending on the type of crane and the configuration of the stabilising struts 22.

The actuation units 24 each comprise a mount 25, in which the relevant stabilising strut 22 is movably mounted. Furthermore, the actuation units 24 each comprise a cable hoist system 30, by means of which the relevant stabilising strut 22 can be inserted and withdrawn. In this case, the insertion relates to a movement of the stabilising strut 22 away from the boom 16 and the withdrawal relates to the opposite movement towards the boom 16.

In the exemplary embodiment shown in FIGS. 4-5, the cable hoist system 30 comprises a single cable winch 32, which is configured as a traversing winch and can thus move the stabilising strut 22 in both directions. For this purpose, the two ends of the cable 34 wound up on the traversing winch 32 are fastened to the opposite ends of the stabilising strut 22. The cable 34 is guided towards the rear end of the stabilising strut 22 via a rear deflection roller 36 of the cable hoist system 30 and is guided towards the front end of the stabilising strut 22 via a front deflection roller 37 of the cable hoist system 30. Furthermore, the cable hoist system 30 comprises a front cable winder 39 and a rear cable winder 38, which each have a further deflection roller and ensure that the cable 34 is always tensioned. Depending on the loads that occur and the configuration of the crane 10, the cable winches 32 can be single-reeved or multiple-reeved.

The stabilising struts 22 can be actively inserted and actively withdrawn via the cable winches 32. In this case, the cable winches 32 are controlled and/or regulated (for example by means of the crane controller) such that the stabilising struts 22 follow the movement of the boom 16 above the defined boom angle, such that the boom 16 can freely tilt back and forward above the defined boom angle in normal operation, but the stabilising struts 22 are still always in contact with the receiving apparatuses 17.

The stabilising struts 22 following the boom is shown in FIGS. 2-3. These figures are a side view of the crane 10 with the boom in different positions. FIG. 2 shows the boom 16 in a position in which the boom angle corresponds to the defined boom angle from which the fallback protection device 20 protects the movement of the boom 16 and in which the stabilising struts 22 are withdrawn to the maximum. FIG. 3 shows the boom 16 in its maximum tilted-back position in which the stabilising struts 22 are inserted to the maximum.

If a critical state of the crane 10 then occurs, such as a load shift, in which the boom 16 suddenly swings back towards the guy frame 18, the insertion movement of the stabilising struts 22 can be braked and ultimately stopped by brake devices 26 of the actuation units 24 in order to prevent the boom 16 and the guy frame 18 from colliding. The brake devices 26 can for example comprise brake blocks, pawls and/or bolts as brake elements.

The brake devices 26 can comprise an active frictional or positive-engagement brake system, which can be hydraulically, electrically or pneumatically actuated. If a critical state is identified, the brake devices 26 are activated and frictional or positive-engagement braking takes place. Alternatively, the stabilising struts 22 can be actively braked by the single-reeved or multiple-reeved cable winches 32.

Alternatively, a passive brake system could also be provided, which for example obtains a corresponding braking action by means of self-locking wedges. This kind of passive brake system also has to be activated in order to brake or block the insertion movement of the stabilising struts 22.

As FIGS. 2-3 show, when the boom 16 tilts, the receiving apparatuses 17 not only move in the horizontal direction, but also in the vertical direction relative to the actuation units 24. Therefore, in the embodiment shown, in which the stabilising struts 22 are configured as linear beams, they also have to follow the boom 16 in the vertical direction. For this purpose, the receiving apparatuses 17 can have an accordingly configured receiving region, which allows the stabilising struts 22 to tilt relative to the receiving apparatuses 17. Furthermore, the actuation units 24 can be actively pivoted, for example individually pivoted, relative to the guy frame 18 by means of actuators. FIG. 1 shows an embodiment in which the actuation units 24 are mounted on a beam 21 which extends in parallel with the boom tilt axis and can be pivoted as a whole in an on the basis of actuators. The actuators for pivoting the stabilising struts 22 can be controlled and/or regulated by means of the same control unit (e.g. the crane controller) as controls/regulates the cable winches 32 based on, for example, instructions stored in a memory of the controller communicating with a processor of the controller, the instructions for carrying out the operations described herein via actuation of the described actuators based on input including from sensors and/or an operator.

In an active brake system, it is necessary to identify the critical state (e.g. the loss of a load or a rolling movement of the ship). This can be done by a sensor system of a detection apparatus of the crane 10, which can be based on different sensors, e.g. acceleration sensors, proximity sensors, mechanical limit switches and/or pressure sensors. The sensor is in particular connected to a control unit which controls or activates the cable winches 32 and/or the brake devices 26.

In the exemplary embodiment shown, the stabilising struts 22 are actively withdrawn and are also actively inserted up to the defined boom angle. Alternatively, they can be inserted passively (in particular due to the boom 16 tilting back), such that a traversing winch 32 does not need to be used.

FIGS. 6-7 show an alternative exemplary embodiment of the crane 10 according to the disclosure in which the stabilising struts 22 are not configured to be straight or linear, but curved. In this case, they are bent or curved downwards. As a result, when following the boom 16, the ends 23 of the stabilising struts 22 pointing towards the receiving apparatuses 17 describe a curve, which follows the movement of the receiving apparatuses 17. The stabilising struts 22 therefore do not need to be followed or pivoted in the vertical direction. The actuation units 24 can therefore be rigidly connected to the guy frame 18, but have to be configured (e.g. by means of an accordingly curved mount 25) such that the curved stabilising struts 22 are movably guided or mounted therein.

FIGS. 1-7 show example configurations (to scale, although other relative dimensions may be used) with relative positioning of the various components. Unless otherwise noted, if shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example.

### LIST OF REFERENCE SIGNS

10 Crane
11 Carrier structure
12 Substructure
13 Boom head
14 Slewing platform
15 Guy cable winch/boom hoist
16 Boom
17 Receiving apparatus
18 Guy frame
19 Guy system
20 Fallback protection device
21 Beam
22 Stabilising strut
23 End
24 Actuation unit
25 Mount
26 Brake device
30 Cable winch system
32 Cable winch
34 Cable
36 Deflection roller
37 Deflection roller
38 Cable winder
39 Cable winder

1. Crane comprising a carrier structure, a boom, which is connected to the carrier structure so as to be pivotable about a horizontal tilt axis, a guy frame, which is connected to the carrier structure and via which the boom is guyed by means of a length-variable guy system, and a fallback protection device, which is arranged on the guy frame and is configured to block or brake tipping of the boom towards the guy frame in a critical state of the crane wherein the fallback protection device comprises at least one stabilising strut, with which the boom comes into contact when it tilts back by a defined boom angle,
wherein
the stabilising strut is configured as a rigid element, which follows the boom above the defined boom angle and can be actively inserted and/or withdrawn relative to the guy frame by means of a cable winch system of the fallback protection device.

2. Crane according to claim 1, wherein the stabilising strut can be actively inserted and/or withdrawn by means of the cable winch system.

3. Crane according to claim 1, wherein the stabilising strut can be actively withdrawn via the cable winch system, and wherein the stabilising strut can be passively inserted.

4. Crane according to claim 1, wherein a receiving apparatus is arranged on the boom, with which apparatus the stabilising strut comes into contact when the defined boom angle is reached.

5. Crane according to claim 1, wherein the stabilising strut is pivotally mounted on the guy frame, in order to compensate for a vertical movement of a contact region of the boom, which is contacted by the stabilising strut, during a pivoting movement of the boom above the defined boom angle.

6. Crane according to claim 1, wherein the stabilising strut has a curved shape and is configured such that a vertical movement of a contact region of the boom, which is contacted by the stabilising strut, during a pivoting movement of the boom above the defined boom angle corresponds to the vertical movement of an end portion of the stabilising strut that contacts the contact region.

7. Crane according to claim 1, wherein the fallback protection device comprises a pressure accumulator which is charged when the stabilising strut is inserted and assists the cable winch system when the stabilising strut is withdrawn.

8. Crane according to claim 1, wherein the fallback protection device comprises a brake device, which, when activated, actively or passively brakes insertion of the stabilising strut.

9. Crane according to claim 1, further comprising a detection apparatus comprising a sensor system for detecting a critical state of the crane, including a load shift, wherein the crane further comprises a control unit, which receives data from the detection apparatus and is configured to actuate a locking device or a brake device of the fallback protection device when a critical state is identified.

10. Crane according to claim 8, wherein the fallback protection device comprises at least one actuation unit comprising a mount which is fastened to the guy frame and in which the stabilising strut is movably mounted, wherein the actuation unit comprises the cable winch system.

11. Crane according to claim 10, wherein the fallback protection device comprises a brake device, which, when activated, actively or passively brakes insertion of the stabilising strut, and wherein the actuation unit comprises the brake device, wherein the brake device is integrated in the mount or the cable winch system.

12. Crane according to claim 11, wherein the mount has a curved shape in order to movably receive the curved stabilising strut.

13. Crane according to claim 1, wherein the fallback protection device comprises at least two stabilising struts, which can be inserted and/or withdrawn via separate cable winch systems.

14. Crane according to claim 1, wherein the carrier structure comprises a slewing platform which is mounted on a substructure so as to be rotatable about a vertical axis of rotation and on which the boom, the guy frame and the fallback protection device are arranged, wherein the crane is a deck crane, and the substructure is connected to a ship's hull.

15. Fallback protection device for a crane according to claim 1.

16. Crane according to claim 2, wherein the cable winch system optionally comprises a cable winch configured as a traversing winch, on which a cable is supported which is guided to different ends of the stabilising strut, over a plurality of deflection rollers, and is fastened there.

17. Crane according to claim 4, wherein the receiving apparatus has a funnel-shaped opening region, into which an end of the stabilising strut facing away from the guy frame is inserted when contacting the receiving apparatus.

18. Crane according to claim 5, wherein the stabilising strut has a linear shape.

19. Crane according to claim 6, wherein the stabilising strut is not pivotally mounted on the guy frame.

20. Crane according to claim 8, wherein the activation takes place automatically by means of a control apparatus when a critical state is identified or whenever the boom comes to a stop, wherein the brake device comprises an active frictional or positive-engagement brake system or a passive brake system that is based on a self-locking wedge.
